(19) United States
(12) Patent Application Publication
(10) Pub. No.: US 2010/0064768 A1
(43) Pub. Date: Mar. 18, 2010

(54) ENHANCEMENT OF VAPOR DETECTION CAPABILITY

(76) Inventors: Talya Arusi-Parpar, Yavne (IL); Izhak Levi, Beer Sheva (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 12/523,731

(22) PCT Filed: Jan. 22, 2007
(86) PCT No.: PCT/IL07/00081

§ 371 Date: Jul. 19, 2009

(51) Int. Cl. G01N 1/44

(52) U.S. Cl. 73/23.2; 73/863.11

(57) ABSTRACT

A vapor detection system adapted to detect vapor from an object at a remote distance therefrom, said vapor detection system comprising a heat source adapted to heat an upper surface of the object so as to increase evaporation and vapor concentrations of substances from the object.

The present invention relates generally to methods for vapor detection and particularly to methods for increasing vapor concentrations of substances to a level high enough to be detected.

### BACKGROUND OF THE INVENTION

The importance of sensitive detection of trace concentrations of illicit or hazardous materials is growing rapidly, mainly for applications in the fields of forensic science and environmental uses. Existing detection methods include X-Ray, Gamma Ray, Nuclear Magnetic Resonance spectroscopy (NMR), Nuclear Quatrupole Resonance spectroscopy (NQR) and Neutron techniques for bulk detection. (See J. Yinon, “Forensic and environmental detection of explosives”, John Wiley & Sons Ltd, England (1999).) The existing systems can not be applied remotely or on people.

Most trace detection methods rely on efficient vapor/trace collection by sniffers, pad swiping or personal screening booths (portals) with particle concentrators. The collected sample is then analytically identified by systems such as Gas Chromatography (GC), Mass Spectrometry (MS) or Ion Mobility Spectrometry (IMS). These methods are very sensitive, robust and technologically mature, however can not be applied in real-time, or be applied remotely (ibid). Detection methods based on optical detection (see J. I. Steinfeld and J. Wormhoudt, “Explosive detection: a challenge for physical chemistry”, Annu. Rev. Phys. Chem. 49, p. 203-232 (1998)), such as Cavity Ring Down Spectroscopy (CRDS) (see M. W. Todd, R. A. Provencal, T. G. Owano, B. A. Paldus, A. Kachanov, K. L. Vodopyanov, M. Hunter, S. L. Coy, J. I. Steinfeld and J. T. Arnold, “Application of mid-infrared cavity-ringdown spectroscopy to trace explosives vapor detection using a broadly tunable (6-8 μm) optical parametric oscillator”, Appl. Phys B, 75, p. 367-376 (2002)) or Tunable Infrared Laser Differential Absorption Spectroscopy (TILDAS) are also proven as very sensitive methods especially when used with long-pass absorption cells however the majority of these methods require sample collection and preparation.

Today researches, who are aiming for sensitive detection of chemicals, use various spectroscopic methods such as REMPI (Resonant Enhanced Multi-Photon Ionization) (see V. Swayambunathan, R. Sausa and G. Singh, “Investigations into trace detection of nitrocompounds by one- and two-color laser photofragmentation/fragment detection spectrometry”, Appl. Spectrosc. 54(5), p. 651-658 (2000) and J. Cabalo and R. Sausa, “Trace detection of explosives with low vapor emissions by laser surface photofragmentation-fragment detection spectroscopy using an improved ionization probe”, Appl. Opt. 44(6) p. 1084-1091 (2005)), Raman and Surface Enhanced Raman Scattering (SERS) (see J. M. Sylvia, J. A. Janni, J. D. Klein and K. M. Spencer, “Surface-enhanced raman detection of 2,4-dinitrotoluene impurity vapor as a marker to locate landmines”, Anal. Chem. 72(23), p. 5834-5840 (2000) and G. Thomson and D. Batchelder, “Development of a hand-held forensic-lidar for standoff detection of chemicals”, Rev. Sc. Instr. 73(12), p. 4326-4328 (2002)), Pulsed Laser Photodissociation (see T. Arusi-Parpar, D. Heflinger and R. Lavi, “Photodissociation followed by laser-induced fluorescence at atmospheric pressure and 24° C.: a unique scheme for remote detection of explosives”, Appl. Opt. 40, p. 6677-6681 (2001) and D. Heflinger, T. Arusi-Parpar, Y. Ron and R. Lavi, “Application of a unique scheme for remote detection of explosives”, Opt. Commun. 204, p. 327-331 (2002)), Photo-fragmentation (see V. Swayambunathan, G. Singh and R. Sausa, “ Laser photofragmentation-fragment detection and pyrolysis-laser-induced fluorescence studies on energetic materials”, Appl. Optics 38(30), p. 6447-6454 (1999)) and LIF (PLP/LIF), LIBS (Laser Induced Breakdown Spectroscopy) (see F. C. De Lucia, Jr., R. S. Harmon, K. L. McNesby, R. J. Winkel, Jr., and A. W. Miziolek, “Laser-induced breakdown spectroscopy analysis of energetic materials”, Appl. Opt. 42 (30), p. 6148-6152 (2003) and A. Portnoy, S. Rosenwaks and I. Bar, “Emission following laser-induced breakdown spectroscopy of organic compounds in ambient air”, Appl. Opt. 42(15), p. 2835-2842 (2003)), LIPS (Laser Induced Plasma Spectroscopy), Luminescence, etc.. Detection by these methods is based on the spectral properties of the material and relies mainly on the light absorption of the vapor which is characteristic for each material. When dealing with the vapor phase, all methods are dependent on the natural vapor concentrations evaporating from the hazardous source. When trying to detect materials with a very low intrinsic vapor pressure the task is very demanding. The conventional way to increase vapor concentrations would include heating of the suspicious object, or collection/preconcentration of the vapor/traces in order to perform analysis by conventional analytical detection instruments which are time consuming and are not remotely applicable. Up-to-date only experimental real-time remote detection of explosives was demonstrated however no operational real-time and remote detection system was developed for the detection of low vapor pressure materials.

### SUMMARY OF THE INVENTION

The present invention seeks to provide methods for increasing vapor concentrations of substances to a level high enough to be detected, as is described hereinbelow. In accordance with a non-limiting embodiment of the invention, the available vapor concentrations are enhanced in the vicinity of the probed area. Remote evaporation of the suspicious object or the material itself may then be carried out by using a light source which heats the examined region or enhances evaporation of the material to be detected. Such a remote heat source evaporates traces of the concealed material and thus increases the vapor concentrations to levels which are high enough to be detected remotely by one of the vapor detection methods.

### BRIEF DESCRIPTION OF THE DRAWINGS

The present invention will be understood and appreciated more fully from the following detailed description, taken in conjunction with the drawings in which:

FIG. 1 is a simplified block diagram of a method and system for increasing vapor concentration for vapor detection, in accordance with an embodiment of the present invention; and

FIGS. 2A and 2B are simplified graphs showing a comparison of detection signals from 2,4,6-trinitrotoluene vapor at ambient conditions from a distance of 2.5 meters, wherein FIG. 2A shows utilizing CO₂ evaporation compared to signal without evaporation assistance and FIG. 2B shows an enlarged view of signal without CO₂ evaporation.

### DETAILED DESCRIPTION OF EMBODIMENTS

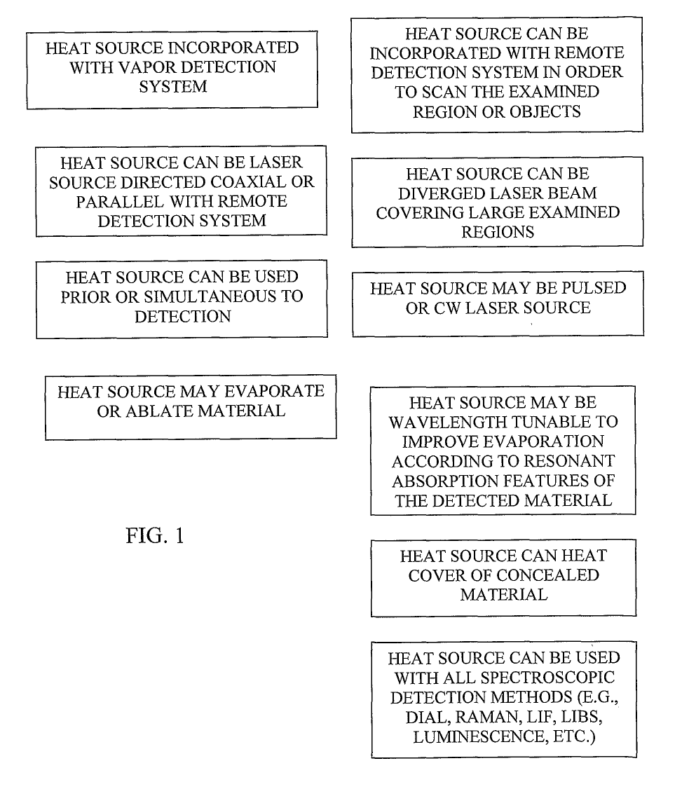

Reference is now made to FIG. 1, which illustrates a method and system for increasing vapor concentration for vapor detection, in accordance with an embodiment of the present invention.

A light or heat source (referred to alternatively herein either as the light source or the heat source) may be incorporated with a vapor detection system in order to evaporate and thus enhance the vapor concentrations to be detected. The heat source can be incorporated with the remote detection system in order to scan the examined region or objects.

Without limitation, the heat source can be a laser source directed coaxial or parallel with the remote detection system. The heat source can be a diverged laser beam covering large examined regions. The heat source can be used prior or simultaneous to detection. The heat source may be a pulsed or CW laser source.

The heat source may evaporate or ablate the material. The heat source can be wavelength tunable to improve evaporation according to resonant absorption features of the detected material.

The heat source can be used to heat the cover of the concealed material.

The heat source can be used with all spectroscopic detection methods, such as DIAL, Raman, LIF (laser-induced fluorescence), LIBS (laser induced breakdown spectroscopy), luminescence, etc.

### Example

A CO₂ laser source was used in cooperation with a known PLP/LIF (pulsed laser photodissociation/laser-induced fluorescence) remote detection system. This PLP/LIF remote detection system has demonstrated a detection sensitivity of 1.5 ppb·m for the detection of standard explosives (see T. Arusi-Parpar, D. Heflinger and R. Lavi, “Photodissociation followed by laser-induced fluorescence at atmospheric pressure and 24° C.: a unique scheme for remote detection of explosives”, Appl. Opt. 40, p. 6677-6681 (2001) and D. Heflinger, T. Arusi-Parpar, Y. Ron and R. Lavi, “Application of a unique scheme for remote detection of explosives”, Opt. Commun. 204, p. 327-331 (2002)).

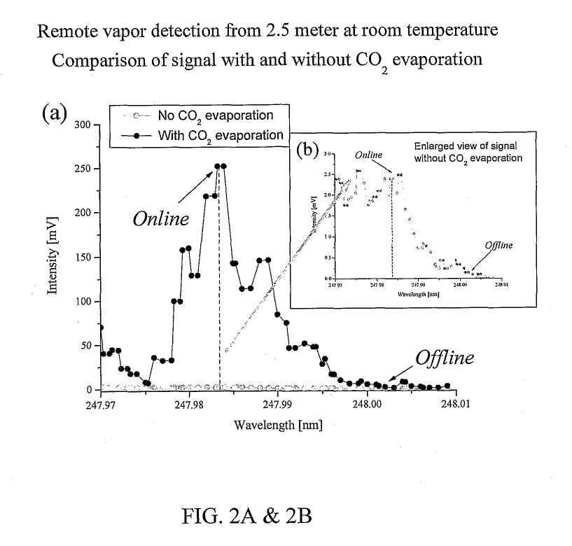

In accordance with methods of the present invention, the inventors successfully demonstrated detection of 2,4,6-trinitrotoluene from a distance of 2.5 meters at room temperature and ambient conditions, obtaining a measurable signal while averaging over 1000 pulses per step (see FIG. 2B).

At similar conditions with additional increased evaporation by a 2W CO₂ laser, which was directed at grazing incident at the solid material, the inventors obtained a PLP/LIF detection signal which was more than two orders of magnitude higher than before while averaging only over 100 pulses (see FIG. 2A). During this experiment nearly no heating of the bulk explosive was obtained. Therefore, it is clear that the evaporation process occurred only on the upper layer of the material.

A signal enhancement of about 2-3 orders of magnitude is obtained by using the CO₂ laser source. Taking into account that the CO₂ laser wavelength is not the optimal wavelength for maximal evaporation, larger enhancement can be expected using a tunable evaporation source. In any case, this experiment proves the significant enhancement in available explosive vapor concentration due to the CO₂ evaporation process.

The scope of the present invention includes both combinations and subcombinations of the features described hereinabove as well as modifications and variations thereof which would occur to a person of skill in the art upon reading the foregoing description and which are not in the prior art.

What is claimed is:

1. A system comprising:
a vapor detection system adapted to detect vapor from an object at a remote distance therefrom, said vapor detection system comprising a heat source adapted to heat an upper surface of the object so as to increase evaporation and vapor concentrations of substances from the object.

2. The system according to claim 1, wherein said heat source does not appreciably heat the object other than the upper surface thereof.

3. The system according to claim 1, wherein said heat source comprises a laser source directed coaxially with said vapor detection system.

4. The system according to claim 1, wherein said heat source comprises a laser source directed parallel with said vapor detection system.

5. The system according to claim 1, wherein said heat source comprises a laser source that emits a diverged laser beam.

6. The system according to claim 1, wherein said heat source comprises a laser source that emits a pulsed laser beam.

7. The system according to claim 1, wherein said heat source comprises a laser source that emits a continuous wave laser beam.

8. The system according to claim 1, wherein said heat source comprises a laser source that is wavelength tunable to improve evaporation according to resonant absorption features of the substances.

9. The system according to claim 1, wherein said heat source is adapted to heat a cover of the object.

10. The system according to claim 1, wherein said heat source comprises a CO₂ laser source and said vapor detection system comprises a PLP/LIF (pulsed laser photodissociation/laser-induced fluorescence) remote detection system adapted to detect vapor from explosives.
